(19) United States
(12) Patent Application Publication
(10) Pub. No.: US 2009/0313029 A1
(43) Pub. Date: Dec. 17, 2009

(54) Method And System For Backward Compatible Multi Channel Audio Encoding and Decoding with the Maximum Entropy

(75) Inventors: Falong Luo, San Jose, CA (US); Norman Shengfa Hu, Guangzhou Guangdong (CN); Xiang Wan, Guangzhou Guangdong (CN)

Correspondence Address: BANNER & WITCOFF, LTD., 1100 13th STREET, N.W., SUITE 1200, WASHINGTON, DC, 20005-4051, US

(73) Assignee: ANYKA (GUANGZHOU) SOFTWARE TECHNOLOGIY CO., LTD., Guangzhou Guangdong, CN (CN)

(21) Appl. No.: 12/373,378

(22) PCT Filed: Jul. 14, 2006
(86) PCT No.: PCT/CN06/01687

§ 371 Date: Jan. 12, 2009

(51) Int. Cl. G10L 21/00

(52) U.S. Cl. 704/500; 704/E21.001

(57) ABSTRACT

A method and system for backward compatible multi-channel audio encoding and decoding in sense of the space information maximum entropy is disclosed. The technical solution according to the invention can adopt any existing stereo channel encoding system to encode the multi-channels audio signals, so as to transmit the multi-channel audio signals at the low bit rate as that of the stereo audio signals. More importantly, the existing stereo channel reproducing systems can also decode the audio format that is encoded utilizing the encoding method according to the invention.

### FIELD OF TECHNOLOGY

The present invention relates to a method and system for encoding and decoding, particularly to a method and system for backward compatible multi-channel audio encoding and decoding in sense of the largest entropy.

### BACKGROUND

Multi-channel audio transmission techniques are increasingly used in modern multimedia and communication systems. However, it remains difficult to deliver multi-channel audio contents in mobile multimedia systems, such as, handheld devices in an efficient manner, because multi-channel encoding systems require a higher bit rate and are more complex than stereo-channel or mono-channel systems. A number of multi-channel audio encoding systems have been proposed and some have been selected or recommended by related experts on standardization. In spite of these efforts, a good compromise among the bit rate, quality and complexity has not been reached yet, simpler and more efficient multi-channel encoding methods for different applications are highly desirable.

### SUMMARY OF THE INVENTION

An object of the present invention is to provide a new and simple method and system for encoding and decoding to achieve a better compromise between performance and complexity in transmitting or storing multi-channel audio contents. Also, the method and system provided by the present invention allow the receiver with existing stereo-channel decoder to still decode the bit stream encoded by the multi-channel encoding system of this invention. Accordingly, the method of this invention is backward compatible. In order to achieve these objects, this invention employs the technical solutions as follows:

According to an embodiment of the invention, there is provided a method for backward compatible multi-channel audio encoding, comprising steps: performing M-point FFTs with a half-overlap window on signals from multiple channels to obtain their frequency responses respectively; dividing FFT-transformed multi-channel spectra into sub-bands; calculating power parameters for each sub-band based on a respective sub-band spectrum; performing constant linear mapping on the FFT-transformed signals from multi-channel or directly on the signals from multi-channel; encoding channel outputs generated in the mapping step to obtain compressed audio outputs; and packing the channel outputs obtained in the encoding step and the power parameters for each of the sub-bands. Wherein the transforming step is the M-point FFTs with a half-overlap window on the entire or a part of the multiple channels.

In the mapping step, the multiple channels may be mapped into several channel outputs, preferably into two channel outputs. The encoder used in the encoding step may be an MP3 encoder, a WMA encoder or an AVS encoder. Preferably, the dividing step is based on critical band analysis.

According to another embodiment of the invention, there is provided a method for backward compatible multi-channel audio decoding, comprising steps: de-packing to separate power parameters from compressed stereo signals; decoding the compressed stereo signals to obtain new stereo outputs; performing M-point FFTs with a half-overlap window on the stereo outputs of the decoding step to obtain frequency responses respectively; dividing a multi-channel spectrum into sub-bands; obtaining new multi-channel spectra by calculation based on the divided sub-bands and the power parameters; performing M-point IFFTs with half-overlap-add on the obtained new multi-channel spectra; and obtaining multi-channel decoded signals by calculation based on the outputs of the IFFTs.

In the transforming steps of the encoding and decoding methods, reference values employed in the M-point FFTs with a half-overlap window are the same. The encoder used in the encoding step and the decoder used in the decoding step are mutually corresponding, wherein the decoder used in the decoding step may be an MP3 decoder, a WMA decoder or an AVS decoder. Additionally, the dividing steps in the encoding method and the decoding method are performed in the same manner which is based on critical band analysis. In the dividing step, the multi-channel spectrum is divided into 10 to 40 sub-bands, preferably into 25 sub-bands.

According to yet another embodiment of the present invention, there is provided a system for backward compatible multi-channel audio encoding, comprising: a transforming means for performing M-point FFTs with a half-overlap window on signals from multiple channels to obtain their frequency responses respectively; a dividing means for dividing FFT-transformed multi-channel spectra into sub-bands; a calculating means for calculating power parameters for each sub-band based on the respective sub-band spectrum; a mapping means for performing constant linear mapping on FFT-transformed signals from the multi-channel or directly on the signals from the multi-channel; an encoding means for encoding channel outputs generated by the mapping means to obtain compressed audio outputs; and a packing means for packing the encoded channel outputs obtained by the encoding means and the power parameters for each of the sub-bands.

The transforming means may perform the M-point FFTs with a half-overlap window on the entire or a part of the multiple channels. In the mapping means, the multiple channels may be mapped into several channel outputs, preferably into two channel outputs. The encoder used by the encoding means may be an MP3 encoder, a WMA encoder or an AVS encoder.

According to still yet another embodiment of the present invention, there is provided a system for backward compatible multi-channel audio decoding, comprising: a de-packing means for separating power parameters from compressed stereo signals; a decoding means for decoding the compressed stereo signals to obtain new stereo outputs; a transforming means for performing M-point FFTs with a half-overlap window on the stereo outputs of the decoding means to obtain frequency responses respectively; a dividing means for dividing a multi-channel spectra into sub-bands; a calculating means for obtaining new multi-channel spectra by calculation based on the divided sub-bands and the power parameters; an inverse-transforming means for performing M-point IFFTs with half-overlap-add on the obtained new multi-channel spectra; and a recovering means for obtaining multi-channel decoded signals by calculation based on the outputs of the inverse-transforming means.

In the encoding system and the decoding system, reference values employed in performing M-point FFTs with a half-length-overlap window in the transforming means are the same. The encoder used in the encoding means and the decoder used in the decoding means are mutually corresponding. The decoder used in the decoding means may be an MP3 decoder, a WMA decoder or an AVS decoder, correspondingly. The dividing means divides the multi-channel spectrum into 10 to 40 sub-bands, preferably into 25 sub-bands, in the same manner which is based on the critical band analysis.

As compared with the existing multi-channel encoding system, the method and system for backward compatible multi-channel audio encoding and decoding according to the invention have the advantages as follows:

1. Bit rate for encoding the multi-channel signals is reduced significantly in that the signals to be encoded are actually just signals of two channels plus the power parameters which are even less than any other existing scheme with side information. Also, the extraction of the power parameters may be easily accomplished by simply performing multi-band FFT (fast Fourier transform) processing on the encoder side and IFFT (inverse fast Fourier transform) processing on the decoder side.

2. The method and system of this invention are backward compatible, that is, the existing stereo decoder can decode the compressed format not only for regular stereo audio but also for the format encoded by the present invention, which simply discards the power parameters in effect and by-passes the remaining processing blocks (FFT, IFT) and filtering on the decoder side.

3. On the corresponding encoder side, parameter extraction and linear mapping are completely independent of stereo-channel encoder. This means that there is no need to make any change to the existing stereo-channel encoder from algorithm to implementation.

4. For further reducing the bit rate and computational complexity, lower values of frequency bands (K) can be chosen, instead of critical bands. The cost of this reduction is the degraded performance.

5. The method and system of this invention is suitable not only for loudspeaker playback with mapping processing, but also for headphone playback. All other audio-effect-related post-processing methods could be added in the method and system provided in this invention. Some of these post-processing, such as base enhancement, can even be accomplished together with high pass filter (HPF) and low pass filter (LPF) in FIG. 3.

6. If the transform-domain stereo-channel encoder is used in the encoder side of the provided method and system, the FFT stage could be embedded with the transform processing in stereo-channel encoder itself.

### BRIEF DESCRIPTION OF THE DRAWINGS

FIG. 1 is a diagram of a method for backward compatible multi-channel audio encoding according to an embodiment of the present invention;

FIG. 2 is a diagram of method for backward compatible multi-channel audio encoding according to another embodiment of the present invention;

FIG. 3 is a diagram of a method for backward compatible multi-channel audio decoding according to an embodiment of the present invention;

FIG. 4 illustrates an implementation of a method for the encoding method according to an embodiment of the present invention, using transform-domain of acoustical system and perception characteristics (masking effect and frequency resolution);

FIG. 5 is a diagram of the configuration of a system for backward compatible multi-channel audio encoding system according to an embodiment of the present invention;

FIG. 6 is a diagram of the configuration of system for backward compatible multi-channel audio encoding according to another embodiment of the present invention;

FIG. 7 is a diagram of the configuration of a system for backward compatible multi-channel audio decoding of the present invention;

### DETAILED DESCRIPTION OF THE INVENTION

### Embodiment 1

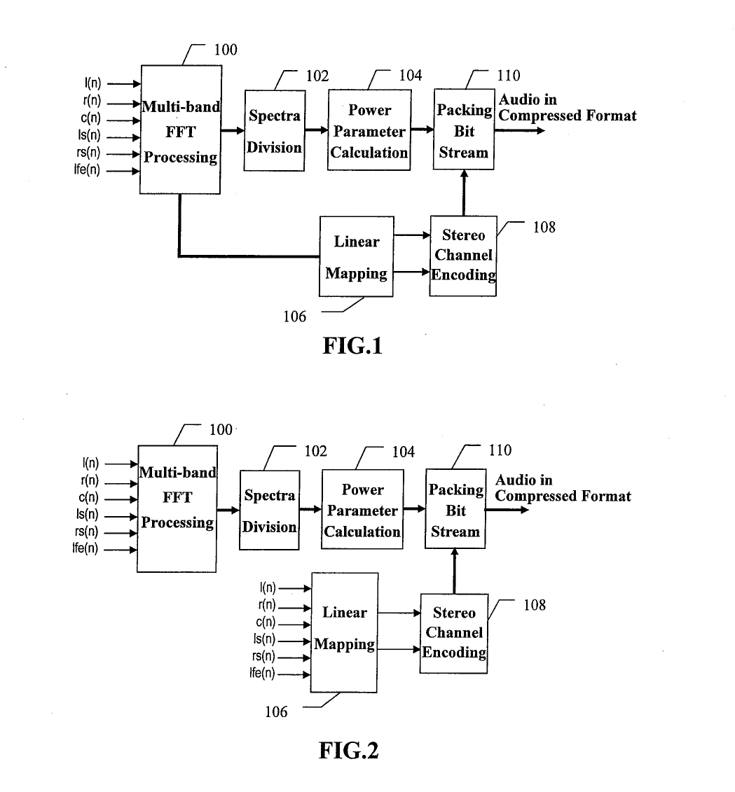

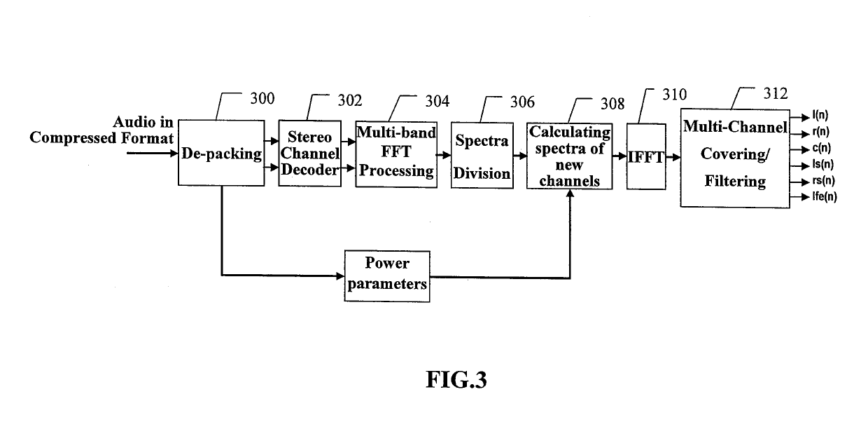

The encoding and decoding methods according to this embodiment, as illustrated in FIGS. 1, 2 and 3, take six channels as examples without losing any generality. The six channels (5.1) are respectively denoted by l(n), r(n), c(n), ls(n), rs(n) and lfe(n) (i.e. left, right, center, left surround, right surround and low-frequency effect signals).

Encoding Process (as Illustrated in FIG. 1)

1. Perform M-point FFTs with a half-overlap window on Channels l(n), r(n), ls(n) and rs(n) (alternatively on part of or all of other channels as appropriately in other cases) (Step 100) to obtain their frequency responses L(m), R(m), LS(m) and RS(m), respectively (reference value M=1024, while other reference values may be used based on practical applications).

2. Divide the spectrum of the four channels into up to 25 sub-bands according to critical band analysis (Step 102), as seen from Table 1:

Tale 1

| Central | Critical | | |
|---|---|---|---|
| Frequency | BW | Frequency | CB Rate |
| Hz | Hz | Hz | bark |
| 50 | 100 | 0 | 0 |
| 150 | 100 | 100 | 1 |
| 250 | 100 | 200 | 2 |
| 350 | 100 | 300 | 3 |
| 450 | 110 | 400 | 4 |
| 570 | 120 | 510 | 5 |
| 700 | 140 | 630 | 6 |
| 840 | 150 | 770 | 7 |
| 1000 | 160 | 920 | 8 |
| 1170 | 190 | 1080 | 9 |
| 1370 | 210 | 1270 | 10 |
| 1600 | 240 | 1480 | 11 |
| 1850 | 280 | 1720 | 12 |
| 2150 | 320 | 2000 | 13 |
| 2500 | 380 | 2320 | 14 |
| 2900 | 450 | 2700 | 15 |
| 3400 | 550 | 3150 | 16 |
| 4000 | 700 | 3700 | 17 |
| 4800 | 900 | 4400 | 18 |
| 5800 | 1100 | 5300 | 19 |
| 7000 | 1300 | 6400 | 20 |
| 8500 | 1800 | 7700 | 21 |
| 10500 | 2500 | 9500 | 22 |
| 13500 | 3500 | 12000 | 23 |
| | | 15500 | 24 |

(It should be noted that there is no overlap of the frequency components among these sub-bands in this implementation. An alternative solution may be 40 sub-bands by using Equivalent Rectangular bandwidth scale.) The sub-band spectra are denoted by Lₖ(m), Rₖ(m), LSₖ(m), RSₖ(m), respectively, wherein k=1, 2, . . . . K (K is the number of critical bands in the half-sampling frequency range and K is up to 25.)

3. Calculate the four power parameters for each sub-band respectively (Step 104), namely:

$${P}_{k}^{L} = \frac{1}{{M}_{k}} {\sum }_{m = 1}^{{M}_{k}} {\vert {L}_{k} ( m ) \vert}^{2} ,$$

power in the k′th band of Left Channel;

$${P}_{k}^{R} = \frac{1}{{M}_{k}} {\sum }_{m = 1}^{{M}_{k}} {\vert {R}_{k} ( m ) \vert}^{2} ,$$

power in the k′th band of Right Channel;

$${P}_{k}^{LS} = \frac{1}{{M}_{k}} {\sum }_{m = 1}^{{M}_{k}} {\vert {LS}_{k} ( m ) \vert}^{2} ,$$

power in the k′th band of Left Surround Channel;

$${P}_{k}^{RS} = \frac{1}{{M}_{k}} {\sum }_{m = 1}^{{M}_{k}} {\vert {RS}_{k} ( m ) \vert}^{2} ,$$

power in the k′th band of Right Surround Channel;
wherein Mₖ is the total number of the frequency components in the k′th band.
Accordingly, the above four spectral parameters represent the space domain information of multi-channel audio signals in the sense of the maximum entropy, based on the spectrum theory proposed in Applied Neural Networks for Signal Processing (by Fa-Long Luo, Rolf Unbehauen, Cambridge University Press, 2000).

4. Perform constant linear mapping on the multi-channel signals (Step 106) to generate two new channel outputs:

lₜ(n)=D₁₁*l(n)+D₁₂*ls(n)+D₁₃*c(n)+D₁₄*lfe(n)+D₁₅*r(n)+D₁₆*rs(n);

rₜ(n)=D₂₁*l(n)+D₂₂*ls(n)+D₂₃*c(n)+D₂₄*lfe(n)+D₂₅*r(n)+D₂₆*rs(n).

The reference values of the 12 parameters may be selected as follows:

D₁₁=1.0, D₁₂=1.0, D₁₃=1/\sqrt{2}, D₁₄=0.001, D₁₅=0.0, D₁₆=0.0,
D₂₁=0.0, D₂₂=0.0, D₂₃=1/\sqrt{2}, D₂₄=0.001, D₂₅=1.0, D₂₆=1.0

5. Encode the stereo signals lₜ(n) and rₜ(n) by using any stereo encoder (codec), such as an MP3 encoder, a WMA encoder or an AVS encoder (Step 108) to obtain compressed audio outputs lₒ(n) and rₒ(n).

6. Further pack the two-channel audio signals in compressed formats with the four sets of parameters in Step 104 (Step 110) for inverse sending.

Additionally, the linear mapping in Step 106 may be performed both in a time domain and in a frequency domain, as illustrated in FIGS. 1 and 2, respectively, wherein the multi-channel signals may be mapped into several new channel output signals, such as one, three or four, preferably two new channel output signals in this embodiment.

Decoding Process

1. De-pack bit stream (Step 300), which simply separates the four sets of parameters Pₖ^{L}, Pₖ^{R}, Pₖ^{LS}, Pₖ^{RS} (k=1, 2, . . . K) from the compressed stereo signals.

2. Decode the compressed lₒ(n) and rₒ(n) (Step 302) by a corresponding decoder (such as an MP3 decoder, a WMA decoder or an AVS decoder) to obtain new stereo outputs i(n) and q(n).

3. Perform M-point FFT with a half-overlap window on signals i(n) and q(n) (Step 304) and obtain the frequency responses I(m), Q(m), respectively (the reference value M=1024, and should be exactly the same as that on the encoder side).

4. Divide the spectra of the two channels into sub-bands in the same manner as in the encoding process (Step 306). The sub-band spectra are denoted by Iₖ(m), Qₖ(m), wherein k=1, 2, . . . K.

5. Obtain the spectra of four new channels denoted by L̅ₖ̅(m), R̅ₖ̅(m), L̅S̅ₖ̅(m), R̅S̅ₖ̅(m) respectively (Step 308) by calculating from the formulas below, based on the sub-band spectra Iₖ(m), Qₖ(m) and power parameters:

$$\overline{{L}_{k}} ( m ) = \sqrt{\frac{{P}_{k}^{L}}{{P}_{k}^{L} + {P}_{k}^{LS}}} {I}_{k} ( m ) ;$$

$$\overline{{LS}_{k}} ( m ) = \sqrt{\frac{{P}_{k}^{LS}}{{P}_{k}^{L} + {P}_{k}^{LS}}} {I}_{k} ( m ) ;$$

$$\overline{{R}_{k}} ( m ) = \sqrt{\frac{{P}_{k}^{R}}{{P}_{k}^{R} + {P}_{k}^{RS}}} {Q}_{k} ( m ) ; and$$

$$\overline{{RS}_{k}} ( m ) = \sqrt{\frac{{P}_{k}^{RS}}{{P}_{k}^{R} + {P}_{k}^{RS}}} {Q}_{k} ( m ) .$$

6. Perform M-point IFFTs with half-overlap-add on the above-described spectra of the four new channels (an inverse processing of the encoding step 100) and obtain four outputs, namely:

$$\overline{l} ( n ) = IFFT ( {\sum }_{k - 1}^{K} \overline{{L}_{k}} ( m ) ) ;$$

$$\overline{ls} ( n ) = IFFT ( {{\sum }_{k - 1}}^{K} \overline{{LS}_{k}} ( m ) ) ;$$

$$\overline{r} ( n ) = IFFT ( {{\sum }_{k - 1}}^{K} \overline{{R}_{k}} ( m ) ) ; and$$

$$\overline{rs} ( n ) = IFFT ( {\sum }_{k - 1}^{K} \overline{{RS}_{k}} ( m ) ) .$$

7. Obtain the 5.1 channel decoded signals through calculations below (Step 312):

l̅ₒ̅(n)=HPF(αₗ* l̅(n)+βₗ*i(n)); αₗ+βₗ=1, reference value: αₗ=0.9, βₗ=0.1;
l̅s̅ₒ̅(n)=HPF(αₗₛ* l̅s̅(n)+βₗₛ*i(n)); αₗₛ+βₗₛ=1, reference value: αₗₛ=0.9, βₗₛ=0.1;
r̅ₒ̅(n)=HPF(αᵣ* r̅(n)+βᵣ*q(n)); αᵣ+βᵣ=1, reference value: αᵣ=0.9, βᵣ=0.1;

r̅s̅ₒ̅(n)=HPF(αᵣₛ* l̅s̅(n)+βᵣₛ*q(n)); αᵣₛ+βᵣₛ=1, reference value: αᵣₛ=0.9, βᵣₛ=0.1;

c̅ₒ̅(n)=HPF(α_{c}*i(n)+β_{c}*q(n)) (reference value α_{c}=0.5, β_{c}=0.5;
l̅f̅e̅ₒ̅(n)=α_{lfe}*LPF( c̅ₒ̅(n)) (reference value: α_{lfe}=1.0);
wherein HPF and LPF are complementary high-pass filter and low-pass filter with the cut-frequency being approximately 80 Hz.

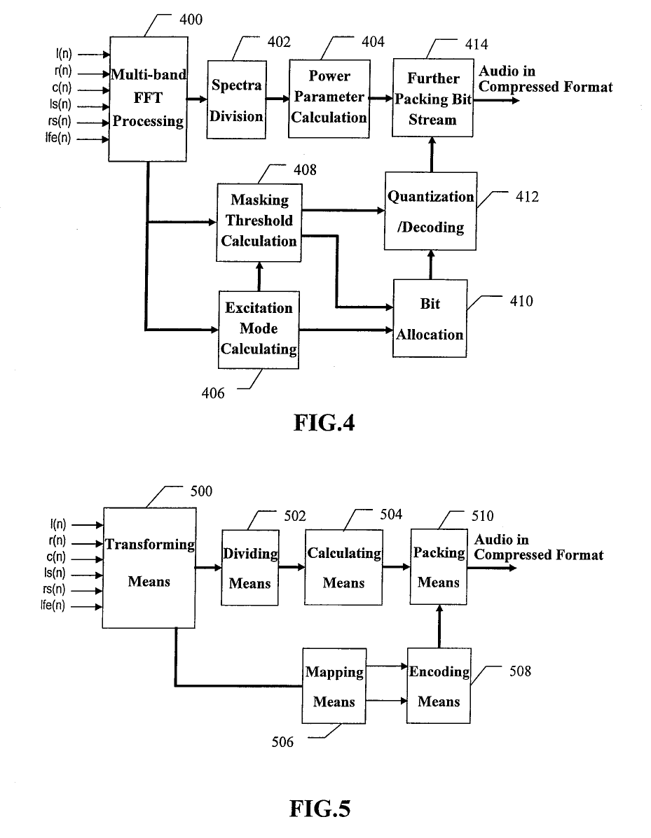

If the stereo channel encoder in transforming domain is used in the encoding step of the method according to the present embodiment, the FFT stage could be embedded with the transform processing of the stereo-channel encoder itself. As further described, FIG. 4 illustrates an implementation of an encoding method of this embodiment by using transform-domain of acoustical system and perception characteristics (masking effect and frequency resolution). This implementation may be summarized in the following steps:

(1) Perform M-point FFT with a half-overlap window on Channels l(n), r(n), ls(n) and rs(n) (Step 400) to obtain their frequency responses L(m), R(m), LS(m) and RS(m), respectively (reference value M=1024, while other reference values may be used based on practical applications).

(2) Divide the spectra of the four channels into up to 25 sub-bands according to critical band analysis (Step 402), as shown in Table 1.

(3) Calculate the four power parameters for each sub-band respectively (Step 404), namely:

$${P}_{k}^{L} = \frac{1}{{M}_{k}} {\sum }_{m = 1}^{{M}_{k}} {\vert {L}_{k} ( m ) \vert}^{2} ,$$

power in the k′th band of Left Channel;

$${P}_{k}^{R} = \frac{1}{{M}_{k}} {\sum }_{m = 1}^{{M}_{k}} {\vert {R}_{k} ( m ) \vert}^{2} ,$$

power in the k′th band of Right Channel;

$${P}_{k}^{LS} = \frac{1}{{M}_{k}} {\sum }_{m = 1}^{{M}_{k}} {\vert {LS}_{k} ( m ) \vert}^{2} ,$$

power in the k′th band of Left Surround Channel;

$${P}_{k}^{RS} = \frac{1}{{M}_{k}} {\sum }_{m = 1}^{{M}_{k}} {\vert {RS}_{k} ( m ) \vert}^{2} ,$$

power in the k′th band of Right Surround Channel;
wherein Mₖ is the total number of the frequency components in the k′th band.

(4) Calculate the excitation mode by using FFT results obtained in Step 400 (Step 406), which includes calculating for an analog output of an auditory filter array in response to the amplitude spectrum. A model is built as an intensity weighting function for each side of each auditory filter, which is assumed to have a formula of:

$$w ( f ) = ( 1 + p \frac{\vert f - {f}_{c} \vert}{{f}_{c}} ) exp ( - p \frac{\vert f - {f}_{c} \vert}{{f}_{c}} ) ;$$

wherein, f_{c} is the central frequency for the filter, and p is a parameter for determining the edge skew of the filter. Assume that the values of p for both sides of the filter are same. The equivalent rectangular bandwidth (ERB) of the filters may correspond to 4f_{c}/p. There may be

$$p \frac{f - {f}_{c}}{{f}_{c}} = \frac{4 ( f - {f}_{c} )}{{f}_{c} ( 0.00000623 {f}_{c} + 0.09339 ) + 28.52}$$

based on the calculation for ERB provided in Spectral Contrast Enhancement. Algorithm and Comparisons (by Jun Yang, Fa-Long Luo and Arye Nehorai, Speech Communication, Vol. 39, No. 1, 2003, pp. 33-46).

(5) Calculate the masking threshold (Step 408) based on the rules known in Psychoacoustics and the excitation mode obtained in Step 406. It should be noted that the amplitude spectrum is to be replaced by a corresponding excitation mode during the calculation for masking threshold based on known rules.

(6) In bit-allocation processing, allocate different bits according to the masking threshold and the amplitude of the excitation mode with different frequency components (Step 410).

(7) Encode all frequencies with different bits according to the bit allocation (Step 412), or use other encoding techniques, such as the Huffman encoding.

(8) Further pack two-channel audio signals in compressed format with the four sets of parameters in Step 404 (Step 414).

### Embodiment 2

The encoding and decoding systems provided in this embodiment, as illustrated in FIGS. 5, 6 and 7, take six channels as examples without losing any generality. The six channels (5.1) are denoted by l(n), r(n), c(n), ls(n), rs(n) and lfe(n) (left, right, center, left surround, right surround and low-frequent effect signals).

Encoding System

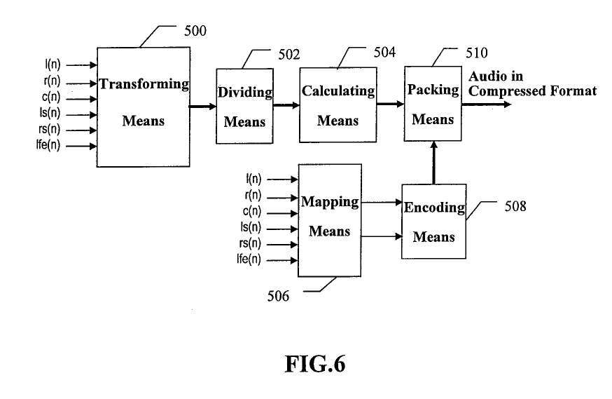

As illustrated in FIGS. 5 and 6, the encoding system includes a transforming means 500, a dividing means 502, a calculating means 504, a mapping means 506, an encoding means 508 and a packing means 510. The transforming means 500 performs M-point FFTs with a half-overlap window on Channels l(n), r(n), ls(n) and rs(n) (alternatively, on part of or all of other channels as appropriately in other cases) to obtain their frequency responses L(m), R(m), LS(m) and RS(m), respectively (reference value M=1024, while other reference values may be used based on practical applications). Then, the dividing means 502 divides the spectra of the four channels into up to 25 sub-bands according to critical band analysis, as seen from Table 1. It should be noted that there is no overlap of the frequency components among the sub-bands in this implementation. Also, an alternative solution may be 40 sub-bands by using Equivalent Rectangular bandwidth scale. The sub-band spectra are denoted by Lₖ(m), Rₖ(m), LSₖ(m), RSₖ(m), respectively, wherein k=1, 2, . . . K (K is the number of critical bands in the range of the half-sampling frequency range and K may be up to 25). According to the sub-band spectra Lₖ(m), Rₖ(m), LSₖ(m), RSₖ(m), calculating means 504 calculates the four power parameters for each sub-band respectively, namely:

$${P}_{k}^{L} = \frac{1}{{M}_{k}} {\sum }_{m = 1}^{{M}_{k}} {\vert {L}_{k} ( m ) \vert}^{2} ,$$

power in the k′th band of Left Channel;

$${P}_{k}^{R} = \frac{1}{{M}_{k}} {\sum }_{m = 1}^{{M}_{k}} {\vert {R}_{k} ( m ) \vert}^{2} ,$$

power in the k′th band of Right Channel;

$${P}_{k}^{LS} = \frac{1}{{M}_{k}} {\sum }_{m = 1}^{{M}_{k}} {\vert {LS}_{k} ( m ) \vert}^{2} ,$$

power in the k′th band of Left Surround Channel; and

$${P}_{k}^{RS} = \frac{1}{{M}_{k}} {\sum }_{m = 1}^{{M}_{k}} {\vert {RS}_{k} ( m ) \vert}^{2} ,$$

power in the k′th band of Right Surround Channel;
wherein Mₖ is the total number of the frequency components in the k′th band.
Accordingly, the above four spectral parameters represent the space domain information of multi-channel audio signals in the sense of the maximum entropy, based on the spectrum theory proposed in Applied Neural Networks for Signal Processing (by Fa-Long Luo, Rolf Unbehauen, Cambridge University Press, 2000).

The mapping means 506 performs constant linear mapping on the signals from multiple channels to generate two new channel outputs:

lₜ(n)=D₁₁*l(n)+D₁₂*ls(n)+D₁₃*c(n)+D₁₄*lfe(n)+D₁₅*r(n)+D₁₆*rs(n);

rₜ(n)=D₂₁*l(n)+D₂₂*ls(n)+D₂₃*c(n)+D₂₄*lfe(n)+D₂₅*r(n)+D₂₆*rs(n);

wherein the reference values for the 12 parameters may be selected as follows:
D₁₁=1.0, D₁₂=1.0, D₁₃=1/\sqrt{2}, D₁₄=0.001, D₁₅=0.0, D₁₆=0.0,
D₂₁=0.0, D₂₂=0.0, D₂₃=1/\sqrt{2}, D₂₄=0.001, D₂₅=1.0, D₂₆=1.0.

Then, the encoding means 508 encodes stereo signals lₜ(n) and rₜ(n) to obtain compressed audio outputs lₒ(n) and rₒ(n), using any stereo encoder (codec), such as MP3 encoder, a WMA encoder or an AVS encoder. The packing means 510 further packs the two-channel audio signals in compressed format with the four sets of power parameters calculated in the calculating means for sending.

Additionally, the input of the mapping means 506 may be coupled to the output of the transforming means and directly to multiple channels, as illustrated in FIGS. 5 and 6, respectively. The mapping means 506 may map the multi-channel signals into several new channel output signals, such as one, three or four, etc., while preferably two new channel output in this embodiment.

Decoding System:

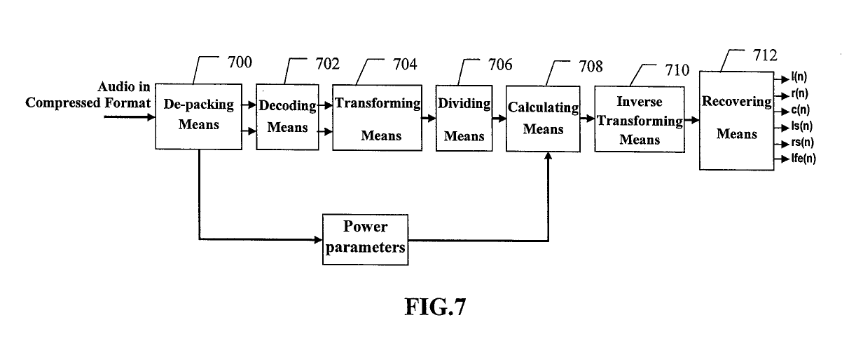

As illustrated in FIG. 7, the decoding system includes a de-packing means 700, a decoding means 702, a transforming means 704, a dividing means 706, a calculating means 708, an inverse transforming means 710 and a recovering means 712.

Bit stream is de-packed by the de-packing means 700, which simply separates the four sets of parameters: Pₖ^{L}, Pₖ^{R}, Pₖ^{LS}, Pₖ^{RS} (k=1, 2, . . . K) from the compressed stereo signals.

The decoding means 702 decodes the compressed lₒ(n) and rₒ(n) by a corresponding decoder (such as an MP3 decoder, a WMA decoder or an AVS decoder) to obtain new stereo outputs i(n) and q(n)

Then, the transforming means 704 performs M-point FFT with a half-overlap window on signals i(n) and q(n) and obtains their frequency responses I(m), Q(m), respectively (reference value M=1024, and should be exactly the same as that used in the encoding system).

The dividing means 706 divides the spectra of the two channels into sub-bands in the same manner as in the encoding system. The sub-band spectra are denoted by Iₖ(m), Qₖ(m), wherein k=1, 2, . . . K.

The calculating means 708 obtains a spectra of four new channels denoted by L̅ₖ̅(m), R̅ₖ̅(m), L̅S̅ₖ̅(m), R̅S̅ₖ̅(m) respectively by calculating from the formulas below, based on sub-band spectra Iₖ(m), Qₖ(m) and power parameters obtained in the dividing means 706:

$$\overline{{L}_{k}} ( m ) = \sqrt{\frac{{P}_{k}^{L}}{{P}_{k}^{L} + {P}_{k}^{LS}}} {I}_{k} ( m ) ;$$

$$\overline{{LS}_{k}} ( m ) = \sqrt{\frac{{P}_{k}^{LS}}{{P}_{k}^{L} + {P}_{k}^{LS}}} {I}_{k} ( m ) ;$$

$$\overline{{R}_{k}} ( m ) = \sqrt{\frac{{P}_{k}^{R}}{{P}_{k}^{R} + {P}_{k}^{RS}}} {Q}_{k} ( m ) ;$$

$$\overline{{RS}_{k}} ( m ) = \sqrt{\frac{{P}_{k}^{RS}}{{P}_{k}^{R} + {P}_{k}^{RS}}} {Q}_{k} ( m ) .$$

Subsequently, the inverse transforming means 710 performs M-point IFFTs with half-overlap-add on the four new channel spectra outputted from the calculating means 708 (an inverse processing of transforming means 500 in the encoding system), and obtains four outputs, namely:

$$\overline{l} ( n ) = IFFT ( {\sum }_{k - 1}^{K} \overline{{L}_{k}} ( m ) ) ;$$

$$\overline{ls} ( n ) = IFFT ( {{\sum }_{k - 1}}^{K} \overline{{LS}_{k}} ( m ) ) ;$$

$$\overline{r} ( n ) = IFFT ( {{\sum }_{k - 1}}^{K} \overline{{R}_{k}} ( m ) ) ; and$$

$$\overline{rs} ( n ) = IFFT ( {\sum }_{k - 1}^{K} \overline{{RS}_{k}} ( m ) ) .$$

Finally, the calculating means 712 obtains the 5.1 channel decoded signals through the calculations below:

l̅ₒ̅(n)=HPF(αₗ* l̅(n)+βₗ*i(n)); αₗ+βₗ=1, reference value: αₗ=0.9, βₗ=0.1;
l̅s̅ₒ̅(n)=HPF(αₗₛ* l̅s̅(n)+βₗₛ*i(n)); αₗₛ+βₗₛ=1, reference value: αₗₛ=0.9, βₗₛ=0.1;
r̅ₒ̅(n)=HPF(αᵣ* r̅(n)+βᵣ*q(n)); αᵣ+βᵣ=1, reference value: αᵣ=0.9, βᵣ=0.1;
r̅s̅ₒ̅(n)=HPF(αᵣₛ* l̅s̅(n)+βᵣₛ*q(n)); αᵣₛ+βᵣₛ=1, reference value: αᵣₛ=0.9, βᵣₛ=0.1;
c̅ₒ̅(n)=HPF(α_{c}*i(n)+β_{c}*q(n)) (reference value α_{c}=0.5, β_{c}=0.5);
l̅f̅e̅ₒ̅(n)=α_{lfe}*LPF( c̅ₒ̅(n)) (reference value: α_{lfe}=1.0);
wherein HPF and LPF are complementary high-pass filter and low-pass filter with the cut-frequency being approximately 80 Hz.

Although the forgoing description includes specific embodiments, the present disclosure will not be limited to the above embodiments. Those skilled in the art may make appropriate additions, reductions, or substitutions to the embodiments as described in order to achieve a similar effect. Any modification, addition, reduction, or substitution made on the embodiments without departing from the spirit of the present disclosure, should be regarded as within the scope of the present disclosure.

What is claimed is:

1. A method for backward compatible multi-channel audio encoding, comprising steps:
performing M-point FFTs with a half-overlap window on signals from multiple channels to obtain their frequency responses respectively;
dividing FFT-transformed multi-channel spectra into sub-bands;
calculating power parameters for each sub-band based on a respective sub-band spectrum;
performing linear mapping on the FFT-transformed signals from multi-channel or directly on the signals from multi-channel;
encoding channel outputs generated in the mapping step to obtain compressed audio outputs; and
packing the channel outputs obtained in the encoding step and the power parameters for each of the sub-bands.

2. A method for backward compatible multi-channel audio decoding, comprising steps:
de-packing to separate power parameters from compressed stereo signals;
decoding the compressed stereo signals to obtain new stereo outputs;
performing M-point FFTs with a half-overlap window on the stereo outputs of the decoding step to obtain frequency responses respectively;
dividing a multi-channel spectrum into sub-bands;
obtaining new multi-channel spectra by calculation based on the divided sub-bands and the power parameters;
performing M-point IFFTs with half-overlap-add on the obtained new multi-channel spectra; and
obtaining multi-channel decoded signals by calculation based on the outputs of the IFFTs.

3. The method according to claim 1, wherein the transforming step is the M-point FFTs with a half-overlap window on the entire or a part of the multiple channels.

4. The method according to claim 1, wherein in the dividing step, the multi-channel spectra are divided into 10 to 40 sub-bands, preferably into 25 sub-bands.

5. The method according to claim 1, wherein, in the mapping step, the signals from the multiple channels are mapped into several channel outputs, preferably into two channel outputs.

6. The method according to claim 2, wherein reference value employed in the M-point FFTs with a half-overlap window in the transforming step is the same as that in the transforming step of the method for backward compatible multi-channel audio encoding.

7. The method according to claim 2, wherein the decoder used in the decoding step corresponds to the encoder used in the encoding step of the method for backward compatible multi-channel audio encoding; wherein the encoder includes an MP3 encoder, a WMA encoder or an AVS encoder; and the decoder includes an MP3 decoder, a WMA decoder or an AVS decoder, correspondingly.

8. The method according to claim 2, wherein the dividing step is performed in the same manner as that of the method for backward compatible multi-channel audio encoding, which is based on critical band analysis.

9. The method according to claim 2, wherein in the dividing step, the multi-channel spectra are divided into 10 to 40 sub-bands, preferably into 25 sub-bands.

10. A system for backward compatible multi-channel audio encoding, comprising:
a transforming means for performing M-point FFTs with a half-overlap window on signals from multiple channels to obtain their frequency responses respectively;
a dividing means for dividing FFT-transformed multi-channel spectra into sub-bands;
a calculating means for calculating power parameters for each sub-band based on the respective sub-band spectrum;
a mapping means for performing constant linear mapping on FFT-transformed signals from the multi-channel or directly on the signals from the multi-channel;
an encoding means for encoding channel outputs generated by the mapping means to obtain compressed audio outputs; and
a packing means for packing the encoded channel outputs obtained by the encoding means and the power parameters for each of the sub-bands.

11. A system for backward compatible multi-channel audio decoding, comprising:
a de-packing means for separating power parameters from compressed stereo signals;
a decoding means for decoding the compressed stereo signals to obtain new stereo outputs;
a transforming means for performing M-point FFTs with a half-overlap window on the stereo outputs of the decoding means to obtain frequency responses respectively;
a dividing means for dividing a multi-channel spectra into sub-bands;
a calculating means for obtaining new multi-channel spectra by calculation based on the divided sub-bands and the power parameters;
an inverse-transforming means for performing M-point IFFTs with half-overlap-add on the obtained new multi-channel spectra; and
a recovering means for obtaining multi-channel decoded signals by calculation based on the outputs of the inverse-transforming means.

12. The system according to claim 10, wherein the transforming means performs the M-point FFTs with a half-overlap window on the entire or a part of the multiple channels.

13. The system according to claim 10, wherein the dividing means divides the multi-channel spectrum into 10 to 40 sub-bands, preferably into 25 sub-bands.

14. The system according to claim 10, wherein the mapping means maps the signals from the multiple channels into several channel outputs, preferably into two channel outputs.

15. The system according to claim 11, wherein the reference value employed in the M-point FFTs with a half-overlap window in the transforming means is the same as that in the system for backward compatible multi-channel audio encoding.

16. The system according to claim 11, wherein the decoder used in the decoding means corresponds to the encoder used in the encoding means of the system for backward compatible multi-channel audio encoding; wherein the encoder includes an MP3 encoder, a WMA encoder or an AVS encoder; and the decoder includes an MP3 decoder, a WMA decoder or an AVS decoder, correspondingly.

17. The system according to claim 11, wherein the dividing means operates in the same manner as that of the system for backward compatible multi-channel audio encoding, which is based on critical band analysis.

18. The system according to claim 11, wherein in the dividing means, the multi-channel spectrum is divided into 10 to 40 sub-bands, preferably into 25 sub-bands.
